(19) United States
(12) Patent Application Publication
(10) Pub. No.: US 2013/0014672 A1
(43) Pub. Date: Jan. 17, 2013

(54) Flame Retardant for Cellulose Based Materials

(71) Applicant: Jean-Valery Martin, Princeton, NJ (US)

(72) Inventor: Jean-Valery Martin, Princeton, NJ (US)

(21) Appl. No.: 13/546,656

(22) Filed: Jul. 11, 2012

Related U.S. Application Data
(60) Provisional application No. 61/506,471, filed on Jul. 11, 2011.

(51) Int. Cl. C08L 1/00; C08K 3/38; C08K 3/32; B05D 7/00

(52) U.S. Cl. 106/18.13; 427/394; 106/18.14

(57) ABSTRACT

Cellulose based insulation materials are treated with phosphate compounds to provide flame retardant properties and reduce or eliminate the propensity of the cellulose based materials to ignite and propagate flame or smolder. The phosphate compounds may be blended with the cellulose based material in a dry process. Alternatively, the phosphate compound may be dissolved or dispersed in water or other solvent and sprayed on the cellulosic material. The cellulose material is then dried prior to use. The treated cellulose materials may be further conditioned prior to use by heating to between 30° C. and 100° C. for 12 to 48 hours.

### CROSS-REFERENCE TO RELATED APPLICATIONS

This application claims priority under 35 U.S.C. § 119(e) to U.S. Provisional Application Ser. No. 61/506,471 filed on Jul. 11, 2011, the entire contents of which are hereby incorporated by reference.

### BACKGROUND

Cellulose fibers have been used in various materials, including in materials used for insulation in homes and other buildings. These materials can be very flammable unless treated to retard or prevent fires. For decades, flame retardant additives have been incorporated in cellulosic fiber based insulating materials to reduce or eliminate the propensity of the material to ignite and propagate flame or smoldering. Those chemical additives typically contain borate components, such as borax and or boric acid, and may contain other additives as well. These compounds can also provide other benefits, such as antifungal properties, and have low solubility to avoid corrosion of metals.

Recently, borate or polyborate materials have been suspected of reprotoxicity and therefore stricter usage regulations may be forthcoming. The characteristics of boric acid or borates are such that it has been difficult to find a substitute to this chemical combining the flame retardant, antifungal property and low solubility preventing metals corrosion. Accordingly, it would be desirable to identify chemicals having the flame retardant properties of the borates that could be added or applied to cellulose based materials, and in particular to cellulose based insulation materials.

### SUMMARY OF THE INVENTION

The present invention is directed treatment of cellulose based insulation materials, such as materials comprising cellulose fibers, with phosphate compounds to provide flame retardant properties and reduce or eliminate the propensity of the cellulosic materials to ignite and propagate flame or smolder. The phosphate compounds may be blended with the cellulose based material in a dry process. Alternatively, the phosphate compound may be dissolved or dispersed in water or other solvent and sprayed on the cellulosic material. The cellulose based material is then dried prior to use.

Additional objects and advantages will be apparent to those skilled in the art based on the detailed description which follows.

### BRIEF DESCRIPTION OF THE DRAWINGS

FIG. 1 is a chart showing the results of blow torch tests using boron phosphate as a flame retardant for cellulose materials.

FIG. 2 is a chart showing the results of blow torch tests using NaAl₃H₁₄(PO₄)₈,4H2O or CaPO₄, H2O as a flame retardant for cellulose materials.

### DETAILED DESCRIPTION OF EMBODIMENTS OF THE INVENTION

The present invention is directed to treatment of cellulose based materials, such as cellulose fibers, with phosphate based compounds to reduce or eliminate the propensity of the cellulose based materials to ignite and propagate flame or smoldering. Phosphate based compounds that may be used to treat the cellulose based materials are listed in Table 1. These materials may be used to treat the cellulose based materials alone or in combination. The phosphate based materials listed in Table 1 have some or all of the characteristics to be used in cellulose based materials as substitutes for boric acid, borax, and polyborates currently used in cellulosic insulation or as a flame retardant in general.

TABLE 1
Product

Active carbon comprising phosphoric acid, polyphosphoric
acid or activated with a phosphate or polyphosphate.
BPO₄ (anhydrous or hydrated)
Phosphate esters (such as Innovalt W)
NaAl₃H₁₄(PO₄)₈, 4H2O (LEVAIR)
Na₃Al₂H₁₅(PO₄)₈ (SALP328)
Na₅Al₄H₁₉(PO₄)₁₂ (SALP5412))
MCP-1
STMP
SPA Catalyst
STPP, 6H2O
Mg₃(PO₄)₂, 8H2O
KH₃P₂O₇
MgHPO₄, 3H2O
ZnHPO₄
NaH₃P₂O₇
NH₄H₃P₂O₇
NH₄H₅(PO₄)₂
KH₅(PO₄)₂
NaH₅(PO₄)₂
Kasal Na₈Al₂(OH)₂(PO₄)₈
Versacal Clear

The phosphates described in Table 1 may be added to the phosphate by blending dry phosphate compounds with the cellulose based material in a dry or solid process. Where a combination of phosphates is used, the phosphates may be first blended together and then blended with the cellulose. Alternatively, the phosphates may be blended separately with the cellulose based materials.

Where the phosphate material has adequate solubility or dispersability, the phosphate material may be dissolved or dispersed in water or other solvent and sprayed on the cellulose material in a wet process. The cellulose material is then dried prior to use.

In either the dry process or the water spray process, an adequate amount of the phosphate material is blended with or sprayed on the cellulose to impart the desired fire retardant properties on the cellulose material. There are various routine tests that one skilled in the art may use to readily determine the amount of phosphate material that must be added to the cellulose material to impart the desired properties. Typically, the phosphate material will comprise between about 0.5% by weight and 30% by weight of the treated cellulose material. In some embodiments, the phosphate material will comprise from about 5% to 15% by weight of the treated cellulose material. In one embodiment, the phosphate material comprises about 10% by weight of the treated cellulose material.

It may be useful, although not always necessary, to condition the treated cellulose material following addition of the phosphate material and prior to use. Typically, conditioning involves heating the treated cellulose material for a period of time following the blending with the phosphate material. The treated cellulose may be maintained at a temperature between 30° C. and 100° C. for a period of 12 hours to 48 hours. In some embodiments, the cellulose material is conditioned at a temperature between about 30° C. and 60° C. In one embodiment, the treated cellulose is conditioned by heating the treated cellulose at about 40° C. for a period of about 24 hours.

The following examples illustrate certain embodiments of the present invention. The examples are not intended to limit the scope of the invention in any way.

### EXAMPLE 1

A first sample was made by blending 90 g of cellulosic fibers with 10 g of BPO₄ anhydrous and conditioned in an oven at 40° C. for 24 hours in a dry or solid process.

A second sample was prepared by dispersing 10 g of BPO₄ in 90 g of water and by spraying the slurry formed onto 90 g of cellulosic fiber, which was thereafter conditioned at 40° C. for 24 hours in a wet process.

A control was prepared by treating a 90 g sample of cellulosic material with boric acid.

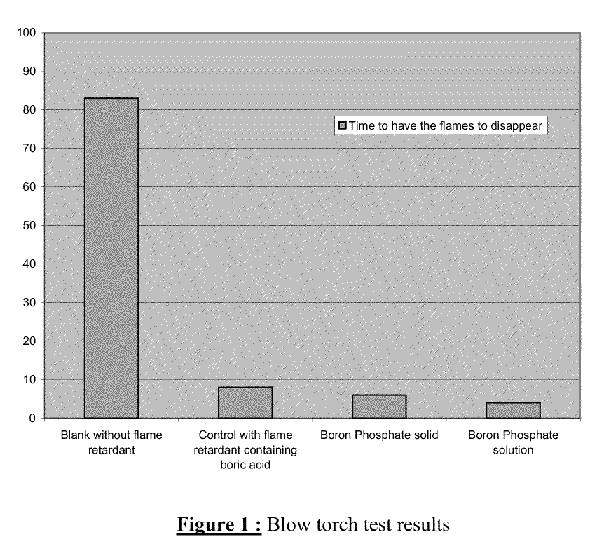

A propane blow torch was applied for 15 seconds on the surface of (1) an untreated sample of cellulose fibers, (2) cellulose fibers treated with typical boric acid flame retardant, (3) cellulose material treated with BPO₄ with the solid process, and (4) cellulose material treated with BPO₄ with the wet process. The time until the flame on the cellulose material disappeared after the torch was removed was monitored and the results are reported in FIG. 1.

The results show that the time until disappearance of the flame with the BPO₄ treated cellulose is much faster than the cellulosic fiber without any flame retardant and slightly faster than for the control product treated with typical boric acid based flame retardant.

### EXAMPLE 2

A sample was made by blending 90 g of cellulosic fibers with 10 g of NaAl₃H₁₄(PO₄)₈, 4H2O (LEVAIR) and conditioned in an oven at 40° C. for 24 hours in a dry or solid process.

An additional sample was prepared by blending 90 g of cellulosic fibers with 10 g of CaPO₄, H2O and conditioned in an oven at 40° C. for 24 hours in a dry or solid process.

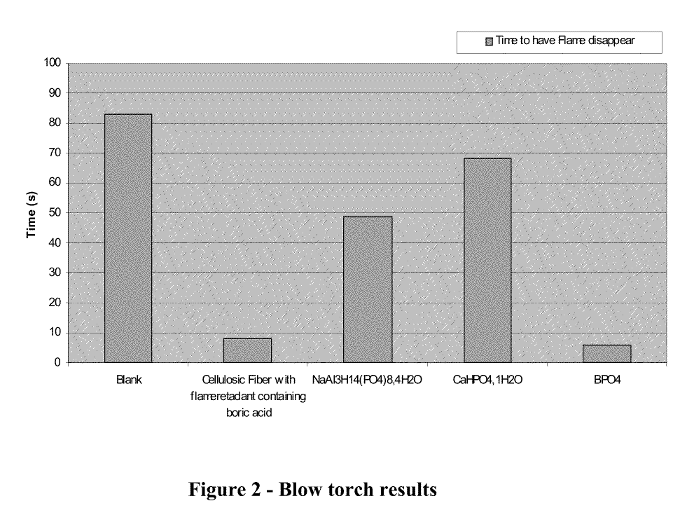

A propane torch was applied to the samples as described above. The time until the flame on the cellulose material disappeared after the torch was removed was monitored and the results are reported in FIG. 2.

The results show that the time until disappearance of the flame with the NaAl₃H₁₄(PO₄)₈, 4H2O or the CaPO₄, H2O treated cellulose is faster than the cellulosic fiber without any flame retardant.

As will be recognized by those of ordinary skill in the art based upon the teachings herein, numerous changes and modifications may be made to the above-described and other embodiments of the invention without departing from its scope as defined in the appended claims. Accordingly, this detailed description of embodiments is to be taken in an illustrative as opposed to a limiting sense.

I claim:

1. A fire retardant cellulose based material comprising;
(a) a cellulose based material, and
(b) a phosphate material, wherein the phosphate material reduces the propensity of the cellulose fibers to propagate flame.

2. The fire retardant cellulose based material of claim 1, wherein the phosphate material comprises between about 0.5% by weight and 30% by weight of the treated cellulose based material.

3. The fire retardant cellulose based material of claim 2, wherein the phosphate material is selected from the group consisting of BPO₄, NaAl₃H₁₄(PO₄)₈, 4H2O, and CaPO₄, H2O and combinations thereof.

4. The fire retardant material of claim 3, wherein the phosphate material comprises about 10% by weight of the treated cellulose based material.

5. The fire retardant material of claim 4, wherein the phosphate material is BPO₄.

6. A process for a flame retardant treatment for cellulose based materials comprising the step of combining a phosphate material with a cellulose based material.

7. The process of claim 6 wherein the phosphate material and the cellulose based material are combined as dry solids.

8. The process of claim 7 wherein the phosphate material comprises between about 0.5% by weight and 30% by weight of the treated cellulose based material.

9. The process of claim 8 wherein the phosphate material is selected from the group consisting of BPO₄, NaAl₃H₁₄(PO₄)₈, 4H2O, and CaPO₄, H2O and combinations thereof.

10. The process of claim 9 wherein the phosphate material comprises about 10% by weight of the treated cellulose based material.

11. The process of claim 9 further including the step of conditioning the treated cellulose based material by maintaining the treated cellulose based material at a temperature of about 30° C. to about 100° C. for a period of about 12 to about 48 hours.

12. The process of claim 11 wherein the treated cellulose based material is maintained at a temperature of about 40° C. for a period of about 24 hours.

13. The process of claim 6 further comprising the steps of mixing the phosphate material with water to form a solution or slurry;
spraying the solution or slurry on the cellulose based material; and
drying the treated cellulose based material.

14. The process of claim 7 wherein the phosphate material comprises between about 0.5% by weight and 30% by weight of the treated cellulose based material.

15. The process of claim 14 wherein the phosphate material is selected from the group consisting of BPO₄, NaAl₃H₁₄(PO₄)₈, 4H2O, and CaPO₄, H2O and combinations thereof.

16. The process of claim 15 wherein the phosphate material comprises about 10% by weight of the treated cellulose based material.

17. The process of claim 15 further including the step of conditioning the treated cellulose based material by maintaining the treated cellulose at a temperature of about 30° C. to about 100° C. for a period of about 12 to about 48 hours.

18. The process of claim 17 wherein the treated cellulose based material is maintained at a temperature of about 40° C. for a period of about 24 hours.
